(19) United States
(12) Patent Application Publication
(10) Pub. No.: US 2007/0052207 A1
(43) Pub. Date: Mar. 8, 2007

(54) Adjustable pin hole for an implement hitch

(76) Inventor: Brian R. Olson, Regina (CA)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/502,950

(22) Filed: Aug. 11, 2006

Related U.S. Application Data
(60) Provisional application No. 60/709,441, filed on Aug. 19, 2005.

(30) Foreign Application Priority Data
Mar. 7, 2006 (CA) 2,538,765

(51) Int. Cl. B60D 1/02

(52) U.S. Cl. 280/515

(57) ABSTRACT

A hitch apparatus includes a hitch member defining a draw pin hole. A hole adjusting member is movably attached to the hitch member such that a front end of the hole adjusting member can be moved forward and rearward, and a threaded actuator is operative, when rotated in a first direction, to move the front end of the hole adjusting member forward to decrease a distance between a front edge of the pin hole and the front end of the hole adjusting member, and is operative, when rotated in a second direction, to move the front end of the hole adjusting member rearward to increase the distance between the front edge of the pin hole and the front end of the hole adjusting member.

### RELATED APPLICATION

The present application claims priority to Canadian Patent Application Serial No. 2,538,765, filed Mar. 7, 2006, and to U.S. Provisional Application Ser. No. 60/709,441, filed Aug. 19, 2005, both which are hereby incorporated by reference.

### FIELD OF INVENTION

This invention is in the field of towed vehicles, such as trailers and agricultural implements, and in particular hitch mechanisms for attaching such towed vehicles to a towing vehicle.

### BACKGROUND

Connecting mechanisms for towed vehicles take a variety of forms, such as ball and socket mechanisms, clevis and tongue mechanisms, pintle hook and ring mechanisms, and the like. A common problem with clevis and tongue connections is that the draw pin holes in the upper and lower clevis members and the draw pin hole in the tongue extending between them are very often of different sizes.

For example in agricultural, an implement is typically hitched to a tractor drawbar by a clevis and tongue connection. The clevis provides an upper and lower clevis members each defining a draw pin hole, and the tongue defines a draw pin hole and is inserted between the clevis members to align the draw pin holes such that a draw pin can be inserted through them and thereby connect the clevis and tongue. Where the draw pin holes are the same size, a corresponding size of draw pin can be inserted to connect the clevis and tongue in the preferred manner such that there is only minimal movement at the connection.

The clevis may be mounted to the tractor drawbar and the tongue mounted to the implement hitch, or vice versa. Tractors come in a wide variety of sizes, and the draw pin hole is typically sized for a pin of sufficient strength to match the power of the tractor. Implements also come in a wide variety, and similarly have a hitch with a draw pin hole that is sized for a pin of sufficient strength to match the power requirement of the implement. Since there are typically a limited number of tractors on a farm that are required to tow a wide variety of implements, often the draw pin holes are of different sizes, and a draw pin that fits through the smaller of the holes must be used. The implement and tractor are thus connected by a loose fitting connection that allows significant movement. Control of the implement is thus reduced, and undesirable shock forces are exerted on the draw pin, implement hitch, and tractor drawbar during use, causing excessive wear.

Similarly trailers are commonly attached to a towing vehicle by a pintle hook and ring mechanism. The pintle hook is typically mounted to the towing vehicle, and a ring member is attached to the trailer hitch and drops over the ring member onto the pintle hook to connect the trailer and towing vehicle. The ring member defines a pintle hook aperture into which the pintle hook must fit. Similar to the clevis and tongue mechanism, it is desirable to have the pintle hook aperture fit the pintle hook quite closely.

This problem has been addressed for example in U.S. Pat. No. 5,671,938 to the present inventor Olson. The disclosed implement hitch provides a hitch member defining a draw pin hole that is adjustable by moving a back portion of the hitch member forward and rearward by securing a variety of spacers in the hitch member, or by securing in the hitch member an auxiliary member that defines a smaller draw pin hole. The disclosed hitch requires considerable machining to make, and as well it also requires a significant amount of time to change the size of the draw pin hole.

### SUMMARY OF THE INVENTION

It is an object of the present invention to provide mechanism for connecting a towed vehicle to a towing vehicle that overcomes problems in the prior art.

The present invention provides, in a first embodiment, a hitch apparatus comprising a hitch member defining a draw pin hole extending substantially vertically therethrough. A hole adjusting member is movably attached to the hitch member such that a front end of the hole adjusting member can be moved forward and rearward. A threaded actuator is operative, when rotated in a first direction, to move the front end of the hole adjusting member forward to decrease a distance between a front edge of the pin hole and the front end of the hole adjusting member, and is operative, when rotated in a second direction, to move the front end of the hole adjusting member rearward to increase the distance between the front edge of the pin hole and the front end of the hole adjusting member.

The present invention provides, in a second embodiment, a hitch apparatus comprising a hitch member defining a draw pin hole extending substantially vertically therethrough. A hole adjusting member is movably attached to the hitch member and slopes upward and rear ward from the draw pin hole to an upright face of the hitch member. A threaded actuator bolt extends substantially vertically through a rear portion of the hole adjusting member, and a threaded end of the threaded actuator bolt is engaged in a threaded aperture. Rotating the threaded actuator in a first direction moves the rear end of the hole adjusting member down along the upright face and moves the front end of the hole adjusting member forward to decrease a distance between a front edge of the pin hole and the front end of the hole adjusting member, and rotating the threaded actuator in a second direction moves the rear end of the hole adjusting member up along the upright face and moves the front end of the hole adjusting member rearward to decrease the distance between the front edge of the pin hole and the front end of the hole adjusting member.

Thus the draw pin hole is adjusted by moving the hole adjusting member forward and rearward into or out of the hole to decrease and increase the distance between the front edge and the front end of the hole adjusting member, which then acts as the rear edge of the pin hole.

When an undersize draw pin is used, the front end of the hole adjusting member is moved forward to decrease the distance between the front edge and the rear edge of the pin hole and thus restrict movement of the draw pin in the draw pin hole. When a larger draw pin is used, the front end of the hole adjusting member is moved rearward to increase the distance between the front edge and the rear edge of the pin hole and thus allow the larger pin to be inserted. The hole adjusting member will typically be positioned such that the pin just fits between the front edge of the hole and the front end of the hole adjusting member, thereby restricting movement of the draw pin in the draw pin hole.

The apparatus is simple and economical, and can be adapted to a variety of hitching mechanisms and vehicles.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a perspective view of an embodiment of a hitch apparatus of the present invention;

FIG. 2 is a schematic side view of the embodiment of FIG. 1 with the hole adjusting member adjacent to the rear edge of the pin hole;

FIG. 3 is a schematic side view of the embodiment of FIG. 1 with the hole adjusting member extending into the pin hole;

FIG. 4 a schematic illustration of the position of the front and rear ends of the hole adjusting member as it moves from the position of FIG. 2 to that of FIG. 3;

FIG. 5 is a bottom view of the embodiment of FIG. 1 with the hole adjusting member in the position of FIG. 3 extending into the pin hole 5;

FIG. 6 is a top view of an alternate embodiment of a hitch apparatus of the present invention where the hole adjusting member and the threaded actuator are combined;

FIG. 7 is a bottom view of the embodiment of FIG. 6;

FIG. 8 is a cross-sectional view along line 8-8 in FIG. 1;

FIG. 9 is a bottom view of a further alternate embodiment of the apparatus of the invention where the hole adjusting member and the threaded actuator are combined.

### DETAILED DESCRIPTION OF THE ILLUSTRATED EMBODIMENTS

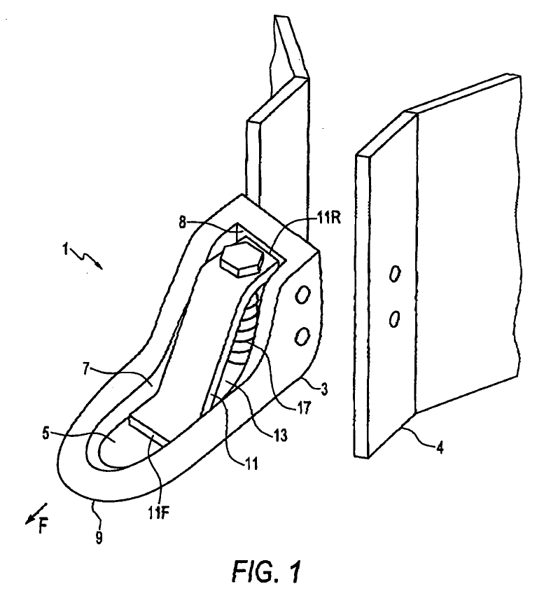

FIGS. 1-5 schematically illustrate an embodiment of the hitch apparatus 1 of the present invention for connecting a towed vehicle to a towing vehicle for movement in a forward operating travel direction F. FIG. 1 illustrates an implement 4 to which the illustrated hitch member 3 is adapted for attachment to provide a tongue for attachment between upper and lower clevis members of a tractor drawbar by a drawbar pin. The apparatus 1 could also be adapted to provide the upper, lower, or both members of a clevis, or could also be adapted to provide the ring member on a pintle hook and ring mechanism. Either the clevis or tongue could be attached to either the towing vehicle or the towed vehicle.

The apparatus 1 comprises a hitch member 3 that defines a substantially vertical draw pin hole 5. A hole adjusting member 11 is movably attached to the hitch member 3 such that a front end 11F of the hole adjusting member 11 can be moved forward and rearward by rotating a threaded actuator, illustrated as bolt 15. The distance between the front edge of the pin hole 5 and the front end 11F of the hole adjusting member 11 is thus increased or decreased to accommodate draw pins of a variety of sizes.

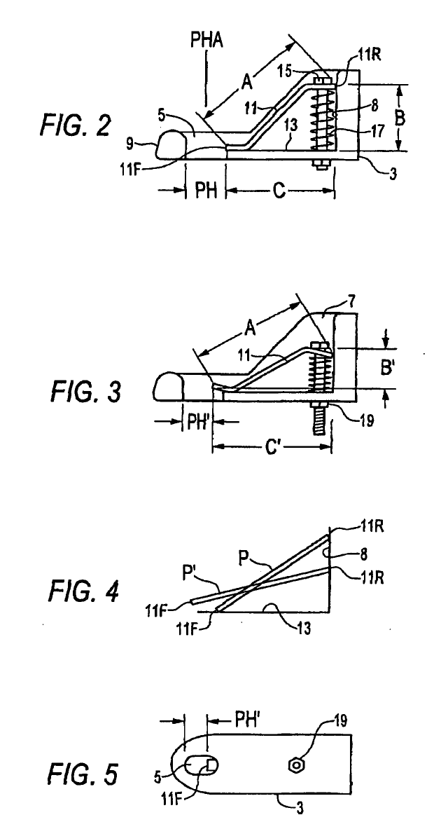

In the embodiment of FIGS. 1-5, the hitch member 3, as seen in FIGS. 2 and 3, defines a recess 7 extending rearward from a rear end of the draw pin hole 5 to an upright face 8. A front portion 9 of the hitch member 3 defines the front edge of the pin hole 5, and the rear edge of the pin hole 5 is defined by a somewhat thinner portion of the hitch member 3 that is within the recess 7. A hole adjusting member 11 is positioned at an angle with respect to a vertical axis PHA of the pin hole 5 and with respect to the floor 13 of the recess 7. The rear end 11R of the hole adjusting member 11 bears against the upright face 8 behind the pin hole 5, and the front end 11F of the hole adjusting member 11 is located in or adjacent to the pin hole 5 and moves forward and rearward as the rear end 11R moves up and down. Thus as the rear end 1 IR moves down from the position illustrated in FIG. 2 to the position illustrated in FIG. 3 the front end 11F moves forward into the pin hole 5 as illustrated.

In FIGS. 2 and 3, the distance A between the front and rear ends 11F, 11R of the hole adjusting member 11 is constant, and as the vertical distance B in FIG. 2 is reduced to B′ in FIG. 3, the horizontal distance C is increased from C in FIG. 2 to C′ in FIG. 3, and the distance PH from the front edge 5F of the pin hole 5 to the front end 11F of the hole adjusting member is reduced from PH in FIG. 2 to PH′ in FIGS. 3 and 5 to restrict movement of the drawbar pin in the pin hole 5 when the drawbar pin is small.

In the illustrated embodiment the threaded actuator bolt 15 extends through a hole near the rear end 11R of the hole adjusting member 11 and down through a compression spring 17 and through another hole in the floor 13 of the recess 7A and into a nut 19. Alternatively a threaded hole could be provided in the floor 13. The configuration of the hole adjusting member 11 is such that the spring 17 biases the rear end 11R of the hole adjusting member 11 upward and also biases the front end 11F thereof downward. Conveniently, the bolt 15 could also be reversed so that the nut 19 was on top and the head of the bolt 15 could be a carriage head bolt recessed into the bottom of the hitch member 3 such that the nut 19, preferably a lock nut, could be turned to move the rear end 11R of the hole adjusting member 11 up or down without also requiring a wrench to be engaged on the bolt head.

The triangular configuration of the hole adjusting member 11, the face 8, and the floor 13 requires that as the rear end 11R of the hole adjusting member 11 moves down, the front end 11F thereof bears against the floor and is prevented from moving down, and so moves forward into the pin hole 5. Conversely, when the rear end 11R of the hole adjusting member 11 moves up, the front end 11F thereof moves rearward out of the hole 5.

While the hole adjusting member 11 is bent near each end, the actual distance between the front and rear ends 11F, 11R thereof is illustrated in FIG. 4, and shows the triangular movement between the position P of FIG. 2 and position P′ of FIG. 3. Because of the bends in the hole adjusting member 11, the front end 11F actually moves up somewhat as it moves forward however the recess 7 serves to confine the hole adjusting member 11 to the desired lateral location within the recess 7 and extending the desired distance into the hole as dictated by the vertical position of the rear end 11R of the hole adjusting member 11.

By turning the bolt 15 in the nut 19, the position of the front end 11F of the hole adjusting member 11 in the draw pin hole 5 can be adjusted, and effectively change the size of the draw pin hole 5. A draw pin that is somewhat smaller in diameter than the draw pin hole 5, is thus prevented from moving forward and rearward in the draw pin hole 5, reducing shock forces on the apparatus 1 and draw pin and increasing control of a towed vehicle.

When towing an implement, trailer, or like vehicle, the towing force is exerted in direction F against the front end of the draw pin hole 5 defined by the thick front portion 9 of the hitch member 3, and the hole adjusting member 11 is thus not subjected to significant forces during most operations. When operating in reverse, or during sharp turns, forces will be exerted on the front end 11F of the hole adjusting member 11, however such operations are usually done at lower speeds for only short periods of time. Also agricultural implements are not typically engaging the ground when moving in reverse, such that the reverse forces on the front end 11F of the hole adjusting member 11 are usually significantly less than forward towing forces. In any event the hole adjusting member and associated elements will be designed as required to provide the necessary service in the design application. The apparatus 1 can readily be scaled up or down as required for the particular application.

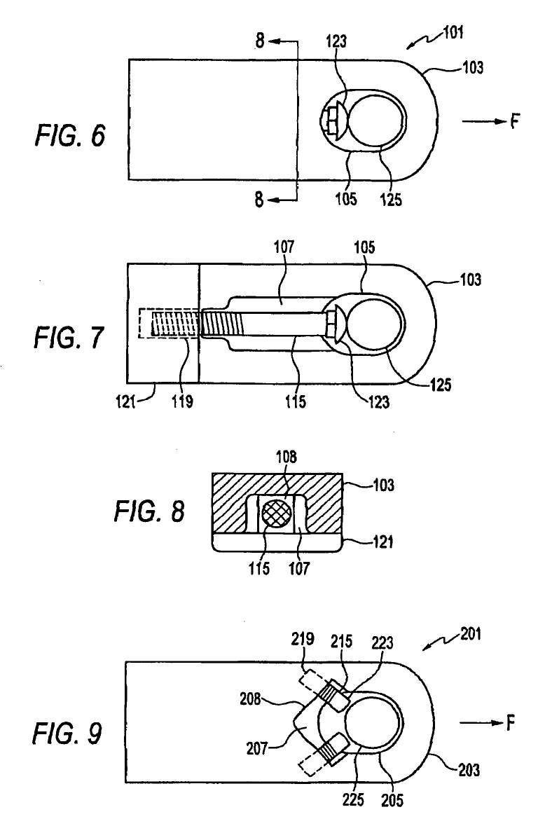

Alternate embodiments of the apparatus 101, 201 are illustrated in FIGS. 6-9, where the threaded actuator, bolts 115, 215 are engaged in forward facing threaded hole 119, 219 in the hitch member 103, 203 such that the bolts 115, 215 are oriented substantially horizontal with front ends thereof, provided by the heads 123, 223 extending into the draw pin hole 105, 205. In these embodiments the hole adjusting member and the threaded actuator are combined and provided by the bolts 115, 215.

The apparatus 101 illustrated in FIGS. 6-8 comprises a hitch member 103 that defines a draw pin hole 105. The bottom of the hitch member 103, as seen in FIG. 6, defines a recess 107 extending rearward from a rear end of the draw pin hole 105. A rear portion 121 of the hitch member 103 is somewhat thicker than the forward portion thereof to provide added strength to the apparatus 101. A threaded hole 119 is defined by the rear portion 121 of the hutch member 103 from the rear face 108 of the recess into the rear portion 121. A threaded actuator, illustrated as a carriage bolt 115, is threaded into the threaded hole 119 and has a front end at head 123 that is shown extending into the rear portion of the draw pin hole 105. By turning the carriage bolt 115 into or out of the threaded hole 119, the position of the head 123 in the draw pin hole 105 can be adjusted, and effectively change the size of the draw pin hole 105. A draw pin 125, that is somewhat smaller in diameter than the draw pin hole 105, is thus prevented from moving forward and rearward in the draw pin hole 105, reducing shock forces on the apparatus 101 and draw pin 125 and increasing control of a towed vehicle.

The illustrated draw pin hole 105 is shown somewhat oblong, to allow for easier visibility and access to the carriage bolt 115, however it is contemplated that a circular draw pin hole could be used as well. It is contemplated that a flat headed bolt could be used instead of the illustrated carriage bolt 115 however the carriage bolt conveniently provides a rounded head 123 and a square shank that is available for engagement by a wrench for adjustment. A lock nut can be provided to more securely retain the carriage bolt 123, or like threaded member, in the threaded hole 119 at the desired location.

FIG. 9 illustrates an alternate apparatus 201 of the invention comprising a hitch member 203 that defines a draw pin hole 205. The bottom of the hitch member 203 defines a recess 207 extending rearward from a rear end of the draw pin hole 205 and having rear faces 208 oriented at an angle to the forward operating travel direction F. First ands second threaded holes 219 are defined by the hitch member 203 from each rear face 208 rearward into the hitch member 203.

A threaded actuator, illustrated as a set screw 215, is threaded into each threaded hole 219 and has a head 223 that is shown extending into the rear portion of the draw pin hole 205 at an angle as illustrated. The set screw 215 has a hexagonal or like recess in the end of the head 223 for engaging with a wrench. By turning the set screws 215 into or out of the threaded holes 219, the position of the heads 223 in the draw pin hole 205 can be adjusted, and effectively change the size of the draw pin hole 205. The longitudinal axes of the first and second threaded holes 219 are oriented to intersect at a location inside the draw pin hole 205, such that the heads 223 bear against laterally spaced rear areas of the drawbar pin 225. Thus a draw pin 225, that is somewhat smaller in diameter than the draw pin hole 205, is prevented from moving forward and rearward in the draw pin hole 205, as in the embodiment of FIGS. 6-8, and is as well prevented from lateral movement, thus further reducing shock forces on the apparatus 201 and draw pin 225 and increasing control of a towed vehicle.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1. A hitch apparatus comprising:
a hitch member defining a draw pin hole extending substantially vertically therethrough;
a hole adjusting member movably attached to the hitch member such that a front end of the hole adjusting member can be moved forward and rearward; and
a threaded actuator operative, when rotated in a first direction, to move the front end of the hole adjusting member forward to decrease a distance between a front edge of the pin hole and the front end of the hole adjusting member, and operative, when rotated in a second direction, to move the front end of the hole adjusting member rearward to increase the distance between the front edge of the pin hole and the front end of the hole adjusting member.

2. The apparatus of claim 1 wherein the hole adjusting member slopes upward and rear ward from the draw pin hole to an upright face of the hitch member, and wherein the threaded actuator is operative, when rotated in the first direction, to move a rear end of the hole adjusting member down along the upright face to move the front end of the hole adjusting member forward, and is operative, when rotated in the second direction, to move the rear end of the hole adjusting member up along the upright face to move the front end of the hole adjusting member rearward.

3. The apparatus of claim 2 wherein the threaded actuator comprises a bolt extending substantially vertically through a rear portion of the hole adjusting member, and wherein a threaded end of the bolt is engaged in a threaded aperture.

4. The apparatus of claim 3 wherein the threaded aperture is defined by one of a nut and the hitch member.

5. The apparatus of claim 3 comprising a bias element exerting a bias force upward on the rear end of the hole adjusting member.

6. The apparatus of claim 5 wherein the hole adjusting member is configured such that the bias element further exerts a downward force on the front end of the hole adjusting member.

7. The apparatus of claim 6 wherein the bias element is provided by a coil spring under the rear end of the hole adjusting member, and wherein the threaded actuator extends downward through the hole adjusting member and then through the coil spring.

8. The apparatus of claim 1 wherein the threaded actuator is engaged in a forward facing threaded hole in the hitch member such that the threaded actuator is oriented substantially horizontal with a front end thereof extending into the draw pin hole, and wherein the front end of the hole adjusting member is provided by the front end of the threaded actuator.

9. The apparatus of claim 8 comprising first and second threaded actuators engaged in corresponding first and second threaded holes in the hitch member.

10. The apparatus of claim 9 wherein longitudinal axes of the first and second threaded holes intersect at a location inside the draw pin hole.

11. A hitch apparatus comprising:
a hitch member defining a draw pin hole extending substantially vertically therethrough;
a hole adjusting member movably attached to the hitch member and sloping upward and rear ward from the draw pin hole to an upright face of the hitch member;
a threaded actuator bolt extending substantially vertically through a rear portion of the hole adjusting member, and a threaded end of the threaded actuator bolt engaged in a threaded aperture;
wherein rotating the threaded actuator in a first direction moves the rear end of the hole adjusting member down along the upright face and moves the front end of the hole adjusting member forward to decrease a distance between a front edge of the pin hole and the front end of the hole adjusting member; and
wherein rotating the threaded actuator in a second direction moves the rear end of the hole adjusting member up along the upright face and moves the front end of the hole adjusting member rearward to decrease the distance between the front edge of the pin hole and the front end of the hole adjusting member.

12. The apparatus of claim 11 comprising a bias element exerting a bias force upward on the rear end of the hole adjusting member.

13. The apparatus of claim 12 wherein the hole adjusting member is configured such that the bias element further exerts a downward force on the front end of the hole adjusting member.

14. The apparatus of claim 13 wherein the bias element comprises a coil spring under the rear end of the hole adjusting member, and wherein the threaded actuator extends downward through the hole adjusting member and then through the coil spring.

15. The apparatus of claim 11 wherein the threaded aperture is defined by one of a nut and the hitch member.
